(19) United States
(12) Patent Application Publication
(10) Pub. No.: US 2024/0160543 A1
(43) Pub. Date: May 16, 2024

(54) DATAPATH INTEGRITY TESTING, VALIDATION AND REMEDIATION

(71) Applicant: Meta Platforms, Inc., Menlo Park, CA (US)

(72) Inventor: Francesco Caggioni, Winchester, MA (US)

(73) Assignee: Meta Platforms, Inc., Menlo Park, CA (US)

(21) Appl. No.: 18/055,172

(22) Filed: Nov. 14, 2022

(51) Int. Cl. G06F 11/263; G06F 11/20

(52) U.S. Cl. CPC G06F 11/2635; G06F 11/2007; G06F 2201/85

(57) ABSTRACT

Systems, apparatuses and methods provide technology that generates first data, stores the first data in a data storage of a first computing device to generate first stored data, transmits the first data as first test data along a first integrity path comprising at least one first hardware device. The technology further receives, with the first computing device, the first test data from the first integrity path and compares the first stored data to the received first test data to determine if a first data path error exists in the first integrity path.

### TECHNICAL FIELD

Embodiments generally relate to detection of silent data errors. More specifically, embodiments relate to systems, apparatuses and methods for identifying silent data errors at a granular level.

### BACKGROUND

Silent data errors may be data errors that go undetected by a system that implements low-level automated error detections. Silent data errors may only become detected when a user identifies that a mistake has occurred on an application or operating system (e.g., bank balance is incorrect), or a system catastrophically fails entirely. Thus, silent data errors are both difficult to detect and have catastrophic consequences. Silent data errors compromise the integrity of platforms, impact efficiency and result in numerous resources being consumed to identify the silent error. Even when a silent error is identified, the specific device causing the silent error may essentially be undetectable given the numerous devices that may exist in any given platform.

### SUMMARY

Some examples include at least one computer readable/writable storage medium comprising a set of instructions, which when executed by a computing system, cause the computing system to generate first data and store the first data in a data storage of a first computing device to generate first stored data. Such examples further include transmitting the first data as first test data along a first integrity path comprising at least one first hardware device, identifying, with the first computing device, the first test data received from the first integrity path, and comparing the first stored data to the received first test data to determine if a first data path error exists in the first integrity path.

Some examples include a system comprising one or more processors, and a memory coupled to the one or more processors. The memory comprising instructions executable by the one or more processors, the one or more processors being operable when executing the instructions to generate first data, and store the first data in a data storage of a first computing device to generate first stored data. Such examples further include transmitting the first data as first test data along a first integrity path comprising at least one first hardware device, identifying, with the first computing device, the first test data received from the first integrity path, and comparing the first stored data to the received first test data to determine if a first data path error exists in the first integrity path.

Some examples include a method comprising generating first data and storing the first data in a data storage of a first computing device to generate first stored data. In such examples the method further includes transmitting the first data as first test data along a first integrity path comprising at least one first hardware device, identifying, with the first computing device, the first test data received from the first integrity path, and comparing the first stored data to the received first test data to determine if a first data path error exists in the first integrity path.

### BRIEF DESCRIPTION OF THE DRAWINGS

The various advantages of the embodiments will become apparent to one skilled in the art by reading the following specification and appended claims, and by referencing the following drawings, in which:

FIG. 1 is an example of a corruption detection system that identifies a failing device based on errors in integrity paths according to an embodiment;

FIG. 2 is an example of a corruption detection system that identifies a failing device in response to integrity path testing resulting in accurate data according to an embodiment;

FIG. 3A is an example of identifying a failing device in an error detection architecture comprising a plurality of nodes according to an embodiment;

FIG. 3B is an example of a silent error mitigation strategy by the error detection architecture according to an embodiment;

FIG. 4 is a flowchart of an example of a method of identifying silent errors and failing devices in a networked system according to an embodiment;

FIG. 5 is a flowchart of an example of a method of remediating silent errors and failing devices in a networked system according to an embodiment;

FIG. 6 is a flowchart of an example of a method of testing a system for silent errors by expanding the integrity path in an incremental fashion according to an embodiment;

FIG. 7 illustrates an example network environment associated with a social-networking system according to an embodiment;

FIG. 8 illustrates an example social graph according to an embodiment; and

FIG. 9 illustrates an example computer system according to an embodiment.

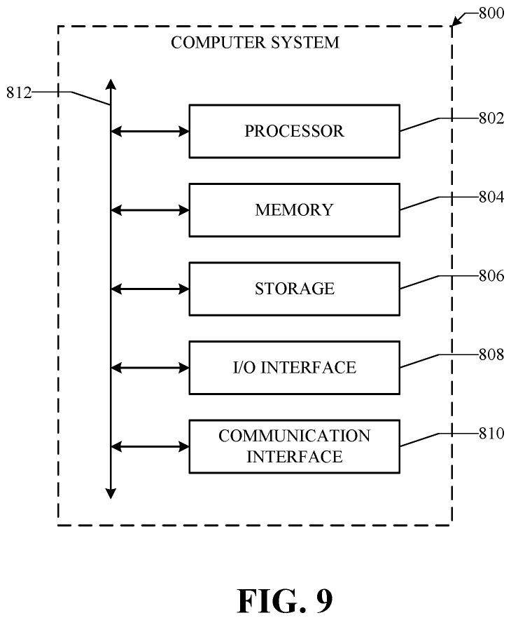

### DESCRIPTION OF EMBODIMENTS

Embodiments relate to a silent error detection system. Silent data errors may be distinguished from typical data errors in that silent data errors may evade networking data integrity checks at a protocol layer, and the employment of typical checking offload techniques (e.g., TX and RX TCP checksum-offloading) allows for a portion of the end-to end communication path to essentially be unguarded against silent errors (e.g. between NIC and CPU). Embodiments herein relate to detecting, mitigating and/or preventing silent data errors. As explained further below, other data protection techniques are unable to detect some types of data corruptions, incur significant power consumption and operate at an application layer level when an application is “live.” Embodiments herein may detect the different types of data corruptions which may otherwise go unnoticed. Further, embodiments do so with reduced power consumption and prior to execution of applications (e.g., not at the application layer).

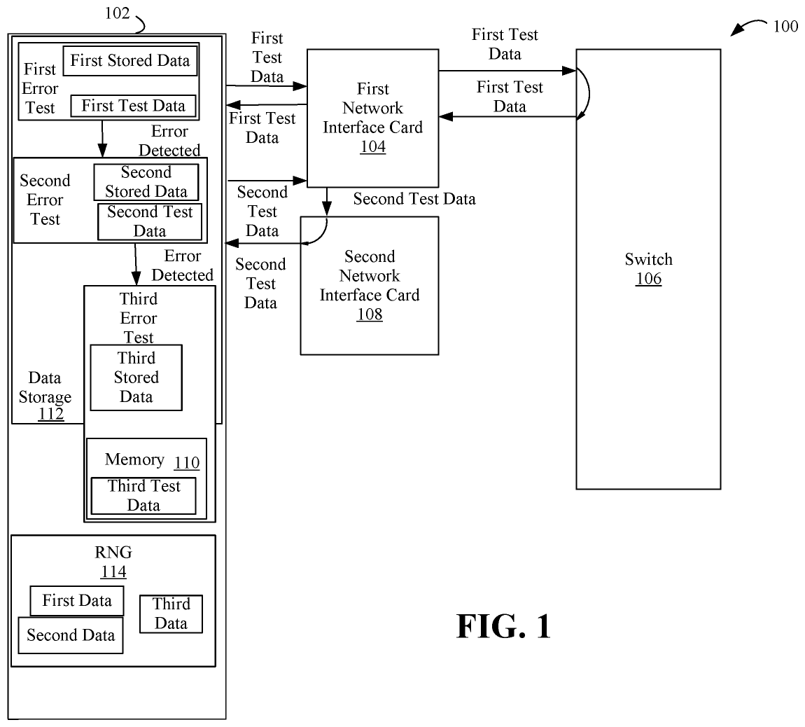

Turning now to FIG. 1, a corruption detection system 100 is illustrated to detect silent errors. Corruption detection system 100 may be implemented in a computing device, computing system (e.g., hardware, configurable logic, fixed-function logic hardware, at least one computer readable storage medium comprising a set of instructions for execution, etc.). The corruption detection system 100 includes a computing device (or system) 102 (e.g., a first computing device), first network interface card (NIC) 104, second NIC 108 and switch 106. Notably, the corruption detection system 100 may accurately detect corruptions (e.g., bit flipping at any point) which may go otherwise unnoticed by other error-detecting techniques such as TCP checksum (and to a lesser extent Cyclic Redundancy Check (CRC)). In detail, the corruption detection system 100 may effectively execute loopback analysis to identify which devices are generating errors (data corruption), and isolate such devices accordingly. Furthermore, embodiments dynamically adjust the loopback operations to identify failing devices (e.g., devices generating the corrupted data).

In this example, an error analysis is being executed on the corruption detection system 100. It will be understood that more than one computing device may be included in some embodiments. In this example, the computing device 102 includes a random number generator (RNG) to generates different testing data. In this example, the RNG 114 generates first data for a first error test. The first data may be stored in a data storage 112 of the computing device 102 to generate first stored data. The computing device 102 further transmits the first data as first test data along a first integrity path comprising the first NIC 104 (e.g., at least one first hardware device), the switch 106 (e.g., at least one first hardware device) and the computing device 102 (e.g., the first computing device). At this point, the first test data that is transmitted to the first NIC 104 and the first stored data are the same (i.e., the first data).

The first error test is a loopback test meaning that the first data routed from a source, which is the computing device 102, back to the source without intentional processing or modification through the first integrity path. Doing so tests the first integrity path for data corruption. The first test data is transmitted through the first NIC 104 to the switch 106. The switch 106 then executes a loopback and transmits the first test data back to the first NIC 104. The first NIC 104 then transmits the first test data to the computing device 102. Thus, the computing device 102 may be considered part of the first integrity path in some examples at least to the extent that first computing device 102 transmits and receives the first data.

The computing device 102 thus receives the first test data from the first NIC 104. The first test data is then stored in the computing device 102 and is at this point received from the first integrity path. The first test data may be corrupted during transmission through the first integrity path. For example, the first NIC 104, the switch 106 or computing device 102 may corrupt the first test data. To verify whether the first data was corrupted, the computing device 102 compares the first stored data to the received first test data to determine if a first data path error exists in the first integrity path. That is, both the first test data, at least when first transmitted by the computing device 102 to the first NIC 104, and the first stored data are the same value (i.e., the first data) as generated by the RNG 114. If the values of the received first test data (e.g., the first test data that was routed through the first integrity path and received from the first integrity path) is the same as the first stored data, a data corruption did not occur in the first integrity path. If the received first test data that was received from the first integrity path is not the same as the first stored data, a data corruption has occurred. Notably, there are three components (e.g., hardware devices) comprising the first integrity path: 1) the computing device 102, 2) the first NIC 104 and 3) the switch 106. Thus, although it may be evident that a device may be failing, it is not yet apparent which of the three components is responsible for the data corruption.

In this example, the first error test results in the first data path error detected (i.e., the first stored data does not match the received first test data). In some examples, each of the components comprising the first integrity path may be placed in a block list. The block list may indicate potential components that are failing. The block list is not yet finalized and will be modified as indicated below.

As a consequence and in response to the above, the corruption detection system 100 determines that a second error test is to be executed. That is, to determine which of the three components comprising the first integrity path are failing, the corruption detection system 100 identifies a second integrity path that is shorter than and overlaps with the first integrity path. In doing so, embodiments may determine which of the three components is failing. That is, if after the second error test is executed, a second data path error is detected, it may be inferred that one of the components common to the first and second integrity paths is responsible for the first and second data path errors (i.e., is the failing device). If no second data path error is identified in the second error test, then it may be inferred that all components common to the first and second integrity paths are functional and not failing, and thus a component of the first integrity path that is not part of both the first and second integrity paths (e.g., is not part of the second integrity path) is responsible for the first data path error in the first error test.

Similar to the above, a loopback test is executed on the second integrity path. In this example, the RNG 114 generates second data. The computing device 102 stores the second data in the data storage 112 to generate second stored data and transmits the second data as second test data along the second integrity path comprising the first NIC 104, the second NIC 108 and the computing device 102. Notably, the second integrity path only partially overlaps with the first integrity path. Doing so enables identifying a failing device based on the results of the second integrity test. The second test data is then transmitted through the first NIC 104 and the second NIC 108 to the computing device 102. Thus, the computing device 102 receives the second test data from the second integrity path. As discussed above, the computing device 102 compares the second stored data to the received second test data to determine if the second data path error exists in the second integrity path. If the second stored data does match the received second test data, then no second data path error exists. If the second stored data does not match the received second test data, then the second data path error exists in the second data path.

In this example, the second stored data does not match the received second test data and thus the second data path error exists. Firstly the corruption detection system 100 may determine which component(s) are not common to both the first and second integrity paths and exclude those component(s) from being a failing component. For example, the corruption detection system 100 may determine that the switch 106 is not common between the first and second integrity paths as the switch 106 is only a part of the first integrity path, and thus cannot be the failing device. That is, since the switch 106 is not part of the second integrity path, the switch 106 cannot be responsible for causing the second data path error in the second integrity path. Otherwise, the second data path error would not exist on the second integrity path.

Based on the second error test detecting the second data path error and the switch 106 not being part of the second integrity path, the switch 106 may be removed from the block list and placed in a allow list that corresponds to healthy components. Notably, the second NIC 108 may not be added to the block list. That is, the first data path error was found in the first integrity path. The first integrity path did not comprise the second NIC 108 and thus the second NIC 108 cannot be responsible for the first data path error in the first integrity path.

In this example, a third test may be executed to determine whether the first NIC 104 is responsible for the first data path error in the first integrity path or the computing device 102. In this example, the corruption detection system 100 generates a third integrity path comprising only the computing device 102. The RNG 114 generates third data. The computing device 102 executes the third error test by storing the third test data into the data storage 112 as third data storage, and then storing the third data into the memory 110 as the third test data. The third stored data is compared to the third test data. If the third test data matches the third stored data, then no third data path error has occurred. If the third test data does not match the third stored data, then the third data path error has occurred. Based on the results of the third error test, embodiments may granularly identify the failing device.

In this example, the third error test identifies the third data path error. The block list contains the computing device 102 and the first NIC 104. Since the third error test shows the third data path error (i.e., that the third stored data does not match the third test data), it is determined that the failing device exists in the third integrity path. The only component in the third integrity path is the computing device 102. Thus, the only component common to both the first and third integrity paths is the computing device 102, and therefore the computing device 102 is maintained on the block list. Furthermore, the first NIC 104 may be identified as not being common to both the first and third integrity paths, and thus, the first NIC 104 may be removed from the block list as the first NIC 104 cannot be responsible for the first and third data path errors in both the first and third integrity paths.

As such, only the computing device 102 remains in the block list. Thus, the computing device 102 may be identified as being the failing machine based on the computing device 102 being the only machine remaining in the block list.

While not illustrated, embodiments may further execute remediation processes. For example, the computing device 102 may be powered down and taken offline. Other computing devices (not illustrated) may receive tasks that were previously scheduled for execution by the computing device 102. A user may also be notified that the computing device 102 is failing.

The corruption detection system 100 may be data center infrastructure. The protocols in some data center infrastructures may include various communication technologies (e.g., Ethernet, Transmission Control Protocol/Internet Protocol (TCP/IP), etc.). The data center infrastructure may employ checksum operations and/or CRC operations to check data in transit for errors (e.g., check the data path from source to the destination, where the destination is across the datacenter or between datacenters to bypass routers). Checksum and CRC however may not be able to catch all errors. For example, the protection provided by CRC and checksum allows for devices to drop ethernet packets that have been identified as being errors. Dropping of such packets results in performance degradation. Thus TCP checksum (and to a lesser extent CRC) cannot guarantee against data corruption ever reaching the Application Layer.

Furthermore, checksum does not detect all data corruptions. For example, a specific example of checksum may be a 16-bit ones-complement sum of data. This sum will catch any burst errors of 15 bits or less, and all 16-bit burst errors except for those which replace one l's complement zero with another (i.e., 16 adjacent 1 bits replaced by 16 zero bits, or vice-versa). Over uniformly distributed data, checksum may be expected to detect other types of errors at a rate proportional to 1 in 2\hat{ }16. The checksum also has a vulnerability in that the sum of a set of 16-bit values is the same, regardless of the order in which the values appear. For example, if a multiple of two bits are flipped anywhere in a data packet, the probability of checksum identifying such an error becomes increasingly small. Moreover, if two chunks of 16 bits are swapped in the data portion of a packet, regardless of which ones and how often, the probability of identifying such a corruption with checksum is 0. Thus, checksum may not detect the transposition of different values in data since the order that values appear is not relevant to the final calculation of the checksum.

Furthermore, deploying the TCP checksum operation in a CPU is also hindered by power and resource requirements. The checksum operation may be offloaded to another hardware device (e.g., a NIC) as opposed to a central processing unit. When data is checked in such a fashion, the data may arrive at the central processing unit but marked with instruction from the another hardware device to not check the data since the data was already checked (the data may be corrupted during transit). A similar error may exist on the transmission path to allow for data to be transferred to the NIC without checksum operations occurring, and the checksum being calculated pre-silent corruption, leading to corrupted packets that may circulate the network.

Embodiments herein may identify such silent errors listed above. Further, embodiments herein may not necessarily operate at the application layer (but may do so if desired) but instead may operate at a lower layer (e.g., presentation, session, transport, network, data link, physical, etc.) of the Open Systems Interconnection (OSI) model.

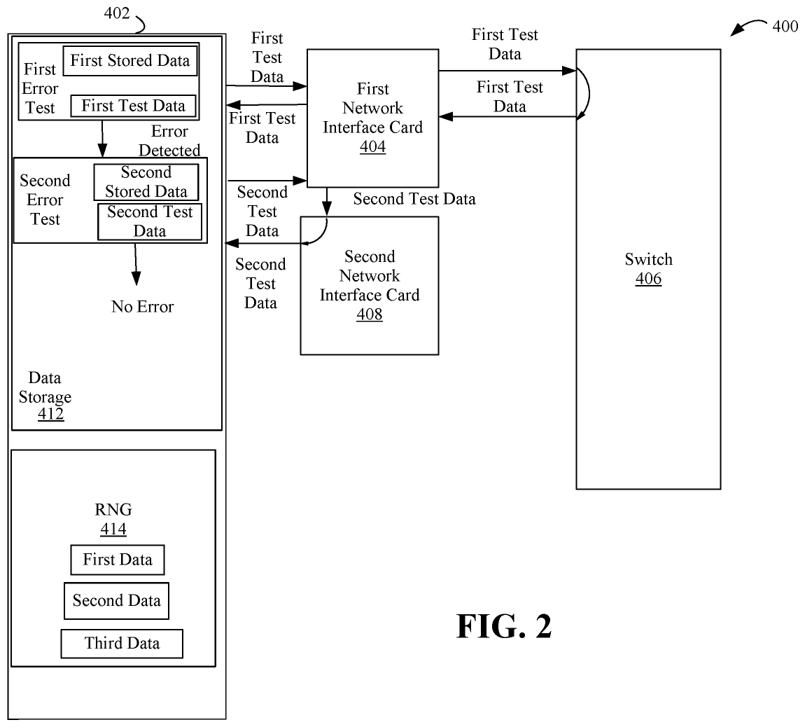

Turning now to FIG. 2, a corruption detection system 400 is illustrated that identifies a failing device in response to integrity path testing resulting in accurate data (i.e., no errors). The corruption detection system 400 detects silent errors. One or more aspects of the may be implemented as part of and/or in conjunction with corruption detection system 100 (FIG. 1) already discussed. Corruption detection system 400 may be implemented in a computing device, computing system (e.g., hardware, configurable logic, fixed-function logic hardware, at least one computer readable storage medium comprising a set of instructions for execution, etc.).

In this example, a first integrity path comprises a first NIC 404, switch 406 and computing device 402. RNG 414 may generate first data that is transmitted through the first integrity path as first test data, and stored in the data storage 412 as first stored data. A comparison of the first test data and the first stored data results in an identification that the first test data does not match the first stored data, and thus, a first data path error is detected as an output of the first error test. The components (e.g., a first plurality of hardware devices) of the first integrity path, the computing device 402, the first NIC 404 and the switch 406, are placed on a block list of possible devices that are failing.

In response to the first data path error being detected, a second error test is executed to ascertain which component in the first integrity path is failing. Embodiments identify a second integrity path that at least partially overlaps with the first integrity path. In this example, the second integrity path includes the computing device 402, the first NIC 404 and the second NIC 408. Thus, the first NIC 404 and computing device 402 are common to both the first integrity path and the second integrity path.

Embodiments determine whether a second data path error exist along the second integrity path. The second integrity path includes a plurality of second hardware devices. Embodiments identify a failing device based on whether the second data path error exists in the second integrity path. When the second data path error exists in the second integrity path, embodiments identify that the failing device is a common device to both the first integrity path and the second integrity path, and when the second data path error does not exist in the second integrity path, embodiments determine that the failing device is a device that is only in the first integrity path but not the second integrity path.

For example, the RNG 414 generates second data. The second data is transmitted as the second test data along the second integrity path though the first NIC 404, the second NIC 408 and the computing device 402. The second data is further stored as second stored data in the data storage 412. In this example, the second stored data matches the received second test data and thus no second data path error is found in the second integrity path. That is, the second integrity path is free of corruption. Thus, the output of the second error test is that no second data path error is identified.

As noted above, the block list contains the computing device 402, the first NIC 404 and the switch 406 (i.e., all the components from the first integrity path). The second integrity path did not produce the second data path error, so as a result, embodiments presume that the components of the second integrity path are not failing. Thus, the block list may be modified to remove any component from the second integrity path that is listed on the block list. That is, the first NIC 404 and the computing device 402 are part of the second integrity path and are part of the block list. As previously stated, no component of the second integrity path is failing, so the first NIC 404 and the computing device 402 are removed from the block list. As such, only the switch 406 remains in the block list and is categorized as the failing device. That is, when the second data path error does not exist in the second integrity path, embodiments determine that the failing device is a device that is only in the first integrity path but not the second integrity path, which in this case is the switch 406.

Thus, embodiments may determine failed devices by systematically generating integrity paths to test different components for corruption. Thus, embodiments not only identify that an error exists, but identify the specific machine that is generating the errors. Furthermore, embodiments apply a more stringent test since the stored data and received data may need to be identical in order to find no evidence of corruption. Thus, silent errors and the sources of such silent errors may be identified, analyzed and reduced.

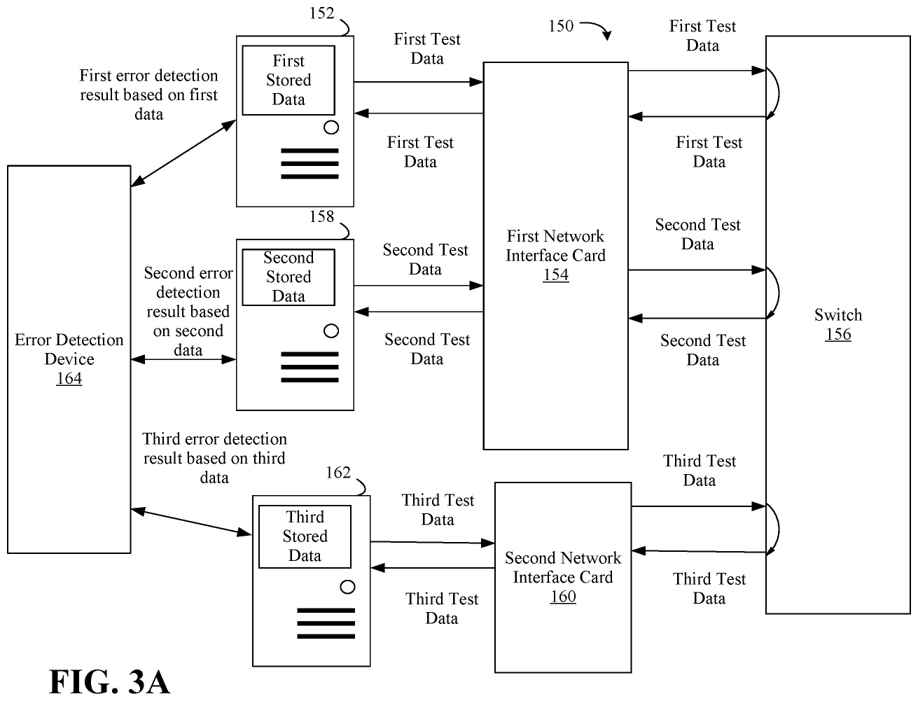

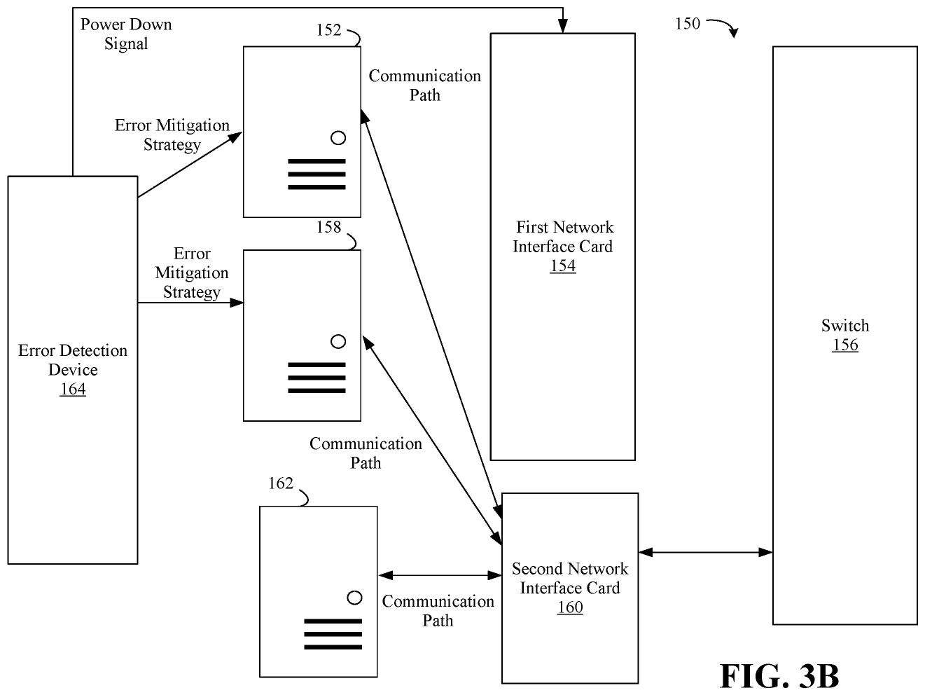

FIG. 3A illustrates an error detection architecture 150 comprising a plurality of nodes. In this example, an error detection device 164 (e.g., a server) may coordinate and execute error detection tests on a plurality of nodes comprising first, second and third servers 152, 158, 162 to detect silent errors. One or more aspects of the error detection architecture 150 may be implemented as part of and/or in conjunction with corruption detection system 100 (FIG. 1) and/or corruption detection system 400 (FIG. 2) already discussed. The error detection architecture 150 may be implemented in a computing device, computing system (e.g., hardware, configurable logic, fixed-function logic hardware, at least one computer readable storage medium comprising a set of instructions for execution, etc.).

In this example, the error detection device 164 identifies a first integrity path to be tested. The first integrity path comprises first server 152, first NIC 154 and switch 156. The first server 152 may generate a first number that is stored as the first stored data and also transmitted as the first test data along the first integrity path in a loopback operation. The received first test data is compared to the first stored data to identify that a first data path error (i.e., a corruption detected) has occurred. That is, the first stored data may not match (is not identical to) the received first test data.

The first server 152 provides the first error detection result (e.g., the first data path error) based on the first data to the error detection device 164. The error detection device 164 thus identifies that the first data path error exists in the first integrity path, and that a device is failing in the first integrity path. To determine which device is failing, the error detection device 164 maps a second integrity path that at least partially overlaps with the first integrity path. The second integrity path comprises the second server 158, the first NIC 154 and the switch 156. The second server 158 may generate a second number that is stored as the second stored data and also transmitted as the second test data along the second integrity path in a loopback operation. The received second test data is compared to the second stored data to identify that a second data path error (i.e., a corruption detected) has occurred. That is, the second stored data may not match (is not identical to) the received second test data.

The second server 158 provides the second error detection result (e.g., the second data path error) based on the second data to the error detection device 164. The error detection device 164 thus identifies that the second data path error exists in the second integrity path, and that a device is failing in the second integrity path. Notably, two components, the first NIC 154 and switch 156, are common to both the first integrity path and the second integrity path. Thus, the error detection device 164 maps a third integrity path to determine which of the first NIC 154 and the switch 156 is the failing component.

That is, the error detection device 164 may determine which of the first NIC 154 and switch 156 is failing by purposefully excluding one of the first NIC 154 and switch 156 from the third integrity path so that only one component is common to each of the first, second and third integrity paths. If a third data path error is found in the third integrity path, it can be assumed that the one component common to the first, second and third integrity paths is failing. Otherwise the excluded component (the component that was common to the first and second integrity paths but not included as part of the third integrity path), is determined to be the failing component.

In this example, the error detection device 164 determines that the first NIC 154 is to be bypassed to not form part of the third integrity path. That is, the third integrity path includes the third server 162, a second NIC 160 and the switch 156. The third server 162 generates third data that is stored as third stored data and transmitted as third test data along the third integrity path in a feedback loop. The received third test data is then compared to the third stored data. In this example, the received third test data matches (i.e., is identical to) the third stored data and thus no third data path error exists in the third integrity path. Based on as much, the error detection device 164 identifies that the failing device is the component that is common to the first and second integrity paths (both of which produced an error), but bypassed for inclusion into the third integrity path (which did not produce an error), or the first NIC 154.

Thus, the specific failing device is identified based on the above. In some embodiments, a block list and/or allow list may be generated based on the identified data path errors. For example, the first server 152, first NIC 154 and switch 156 may be added to a block list based on the first data path error of the first integrity path. The first server 152 may be removed from the block list and added to an allow list based on the second data path error of the second error test since the first server 152 cannot be the cause of the second data path error, and logically may not be a failing machine that causes the first and second data path errors in both the first and second data paths. The second server 158 may also be added to the allow list based on the second data path error of the second integrity test since the second server 158 cannot cause both the first and second data path errors. Thus at this point, the first NIC 154 and switch 156 are part of the block list. As a result of the lack of the third data path error of the third integrity test, the switch 156 may be removed from the block list since no third data path error was found, leaving only the first NIC 154 on the block list. When a number of components of the block list falls beneath a threshold (e.g., only one item remaining), the failing device is identified as the component remaining on the block list.

FIG. 3B illustrates a silent error mitigation strategy implemented by the error detection device 164. As noted, the first NIC 154 is a failing device. Thus, the error mitigation strategy involves bypassing the first NIC 154 from further responsibility or from serving as an interface to other devices for the first and second servers 152, 158. As such, the error detection device 164 establishes communication paths between the second NIC 160 and the first and second servers 152, 158, and assigns the second NIC 160 to the first and second servers 152, 158. That is, the second NIC 160 establishes network connectivity for the first and second servers 152, 158. In order to save power, the error detection device 164 further instructs the first NIC 154 to power down.

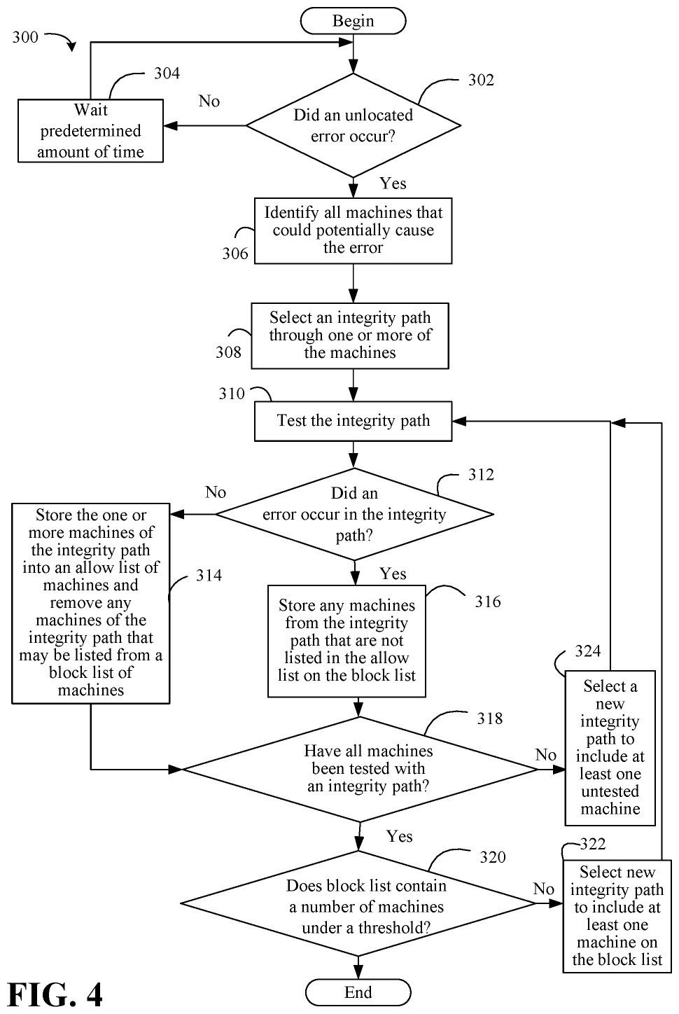

FIG. 4 illustrates a method 300 to identify silent errors and failing devices in a networked system. The method 300 may generally be implemented with the embodiments described herein, for example, corruption detection system 100 (FIG. 1), corruption detection system 400 (FIG. 2) and/or an error detection architecture 150 (FIG. 3A-3B) already. The method 300 may be implemented in a computing architecture. For example, the method 300 may be implemented in a computing device, computing system (e.g., hardware, configurable logic, fixed-function logic hardware, at least one computer readable storage medium comprising a set of instructions for execution, etc.).

Illustrated processing block 302 determines if an unlocated event occurred. An unlocated event may mean that an error was identified, but that a specific machine that caused the error cannot be identified. If not, illustrated processing block 304 waits a predetermined amount of time before re-executing processing block 302. If an unlocated error did occur, illustrated processing block 306 identifies all machines that could potentially cause the error. Illustrated processing block 308 selects an integrity path through one or more of the machines. Illustrated processing block 310 tests the integrity path. For example, processing block 310 may generate random data, store the random data and transmit the random data along the integrity path in a feedback operation. Illustrated processing block 312 determines if an error occurred in the integrity path. For example, processing block 312 determines that an error occurs if the stored random data does not match the received random data, and that an error does not occur if the stored random data does match the received random data. If not (i.e., if no data path error existed), illustrated processing block 314 stores the one or more machines of the integrity path into the allow list of machines and removes any machine of the integrity path that may be listed from a block list of machines.

If an error is detected by processing block 312, illustrated processing block 316 stores any machine from the integrity path, that is not listed in the allow list, onto the block list. Illustrated processing block 318 determines if all machines (i.e., all machines that could potentially cause the error) have been tested with an integrity path. If not, illustrated processing block 324 selects a new integrity path to include at least one untested machine, and processing block 310 executes again.

If processing block 318 determines that all machines have been tested with an integrity path, illustrated processing block 320 determines if the block list contains a number of machines under a threshold (e.g., two so that only one machine is on the block list). If so, the block list may be considered to be finalized and contain the failing device. Otherwise, illustrated processing block 322 selects a new integrity path to include at least one machine on the block list.

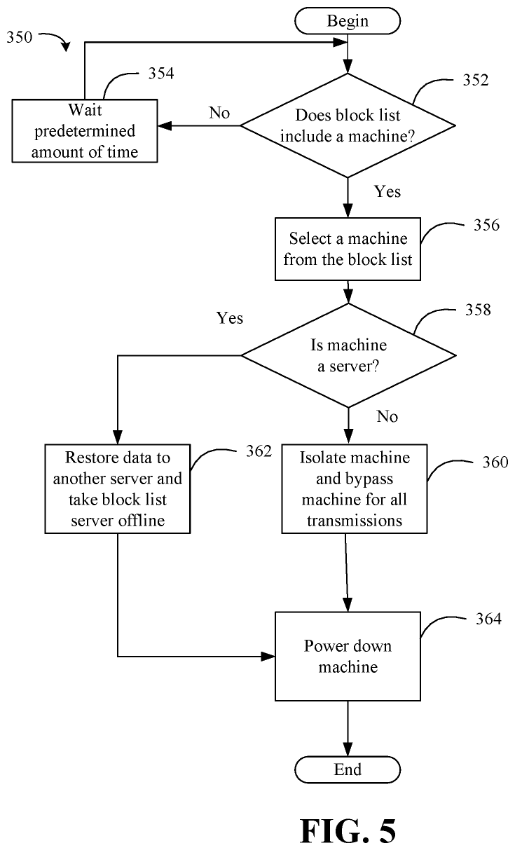

FIG. 5 illustrates a method 350 to remediate silent errors and failing devices in a networked system. The method 350 may generally be implemented with the embodiments described herein, for example, the corruption detection system 100 (FIG. 1), corruption detection system 400 (FIG. 2), an error detection architecture 150 (FIGS. 3A-3B) and/or method 300 (FIG. 4). The method 350 may be implemented in a computing architecture. For example, the method 350 may be implemented in a computing device, computing system (e.g., hardware, configurable logic, fixed-function logic hardware, at least one computer readable storage medium comprising a set of instructions for execution, etc.).

Illustrated processing block 352 determines if a block list includes a machine. The block list may be generated according to the method 300 (FIG. 4). If the block list does not include a machine, processing block 354 waits a predetermined amount of time before processing block 352 is executed again. If the block list does include a machine, illustrated processing block 356 selects a machine from the block list. Illustrated processing block 358 determines if the machine is a server. If so, illustrated processing block 362 restores data to another server and takes the block listed server offline. Otherwise the machine is not a server (e.g., the machine may be a NIC, switch, etc.). In such a case, illustrated processing bock 360 isolates the machine (e.g., disconnects the machine from the network) and bypasses the machine for all transmissions. Processing block 360 may include rerouting communications to other available devices that may be substituted for the failed machine. Illustrated processing block 364 powers does the machine.

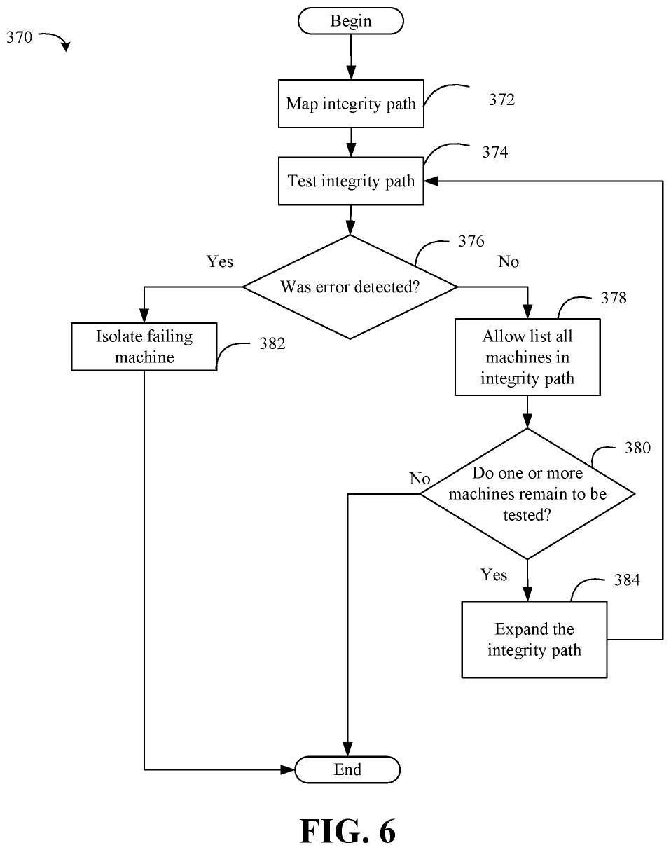

FIG. 6 illustrates a method 370 to test a system for silent errors by expanding the integrity path in an incremental fashion. The method 370 may generally be implemented with the embodiments described herein, for example, the corruption detection system 100 (FIG. 1), corruption detection system 400 (FIG. 2), an error detection architecture 150 (FIG. 3A-3B), method 300 (FIG. 4) and/or method 350 (FIG. 5). For example, the method 370 may be implemented in a computing device, computing system (e.g., hardware, configurable logic, fixed-function logic hardware, at least one computer readable storage medium comprising a set of instructions for execution, etc.).

Illustrated processing block 372 maps an integrity path. The integrity path may initially only include one device in some examples and incrementally expand as described below. Illustrated processing block 374 tests the integrity path as described herein (e.g., determine if transmitted data is the same as stored data). Illustrated processing block 376 determines if an error was detected. If so, the failing machine may be isolated. Otherwise, illustrated processing block 378 allow lists all machines in the integrity path. That is, the machines are not in a fail state since all machines were tested and no errors were detected. Illustrated processing block 380 determines if one or more machines remain to be tested (e.g., machines in a network). If not, the method 370 ends. Otherwise, illustrated processing block 384 expands the integrity path. For example, the integrity path may be expanded in an incremental form (e.g., one hardware device at a time is added to the integrity path) in order to determine which machine is failing. That is, if in the next iteration an error is detected in processing block 376, then it may be presumed that the last added hardware device that is added to the integrity path is the failing machine, and processing block 382 isolates as much.

System Overview

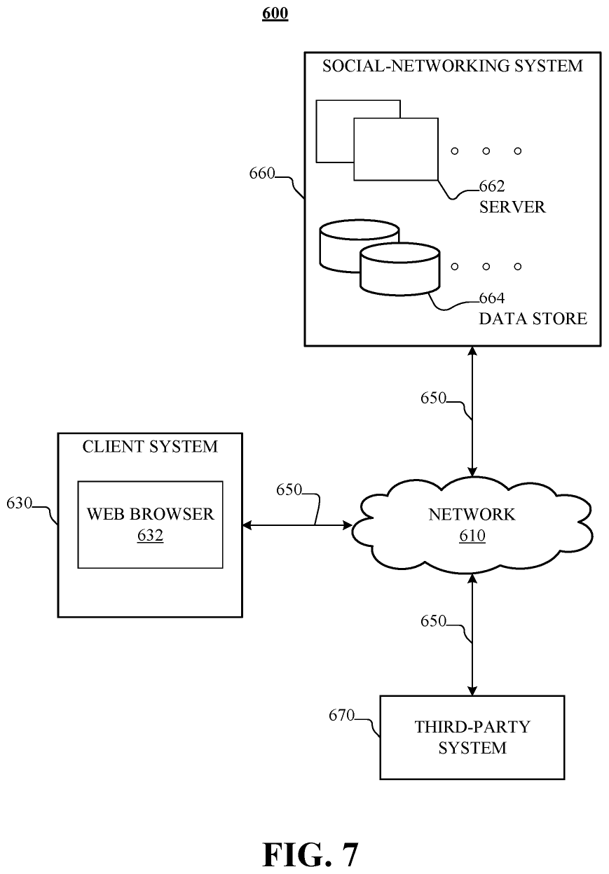

FIG. 7 illustrates an example network environment 600 associated with a social-networking system. Network environment 600 may implement one or more aspects of the corruption detection system 100 (FIG. 1), corruption detection system 400 (FIG. 2), an error detection architecture 150 (FIGS. 3A-3B) and/or method 300 (FIG. 4), and/or method 370 (FIG. 5), already discussed.

Network environment 600 includes a client system 630, a social-networking system 660, and a third-party system 670 connected to each other by a network 610. Although FIG. 7 illustrates a particular arrangement of client system 630, social-networking system 660, third-party system 670, and network 610, this disclosure contemplates any suitable arrangement of client system 630, social-networking system 660, third-party system 670, and network 610. As an example and not by way of limitation, two or more of client system 630, social-networking system 660, and third-party system 670 may be connected to each other directly, bypassing network 610. As another example, two or more of client system 630, social-networking system 660, and third-party system 670 may be physically or logically co-located with each other in whole or in part. Moreover, although FIG. 7 illustrates a particular number of client systems 630, social-networking systems 660, third-party systems 670, and networks 610, this disclosure contemplates any suitable number of client systems 630, social-networking systems 660, third-party systems 670, and networks 610. As an example and not by way of limitation, network environment 600 may include multiple client system 630, social-networking systems 660, third-party systems 670, and networks 610.

This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 650 may connect client system 630, social-networking system 660, and third-party system 670 to communication network 610 or to each other. This disclosure contemplates any suitable links 650. In particular embodiments, one or more links 650 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 need not necessarily be the same throughout network environment 600. One or more first links 650 may differ in one or more respects from one or more second links 650.

In particular embodiments, client system 630 may be an electronic device including hardware, software, or embedded logic components or a combination of two or more such components and capable of carrying out the appropriate functionalities implemented or supported by client system 630. As an example and not by way of limitation, a client system 630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 630. A client system 630 may enable a network user at client system 630 to access network 610. A client system 630 may enable its user to communicate with other users at other client systems 630.

In particular embodiments, client system 630 may include a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 630 may enter a Uniform Resource Locator (URL) or other address directing the web browser 632 to a particular server (such as server 662, or a server associated with a third-party system 670), and the web browser 632 may generate a Hyper Text Transfer Protocol (HTTP) request and communicate the HTTP request to server. The server may accept the HTTP request and communicate to client system 630 one or more Hyper Text Markup Language (HTML) files responsive to the HTTP request. Client system 630 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 660 may be a network-addressable computing system that can host an online social network. Social-networking system 660 may generate, store, receive, and send social-networking data, such as, for example, user-profile data, concept-profile data, social-graph information, or other suitable data related to the online social network. Social-networking system 660 may be accessed by the other components of network environment 600 either directly or via network 610. As an example and not by way of limitation, client system 630 may access social-networking system 660 using a web browser 632, or a native application associated with social-networking system 660 (e.g., a mobile social-networking application, a messaging application, another suitable application, or any combination thereof) either directly or via network 610. In particular embodiments, social-networking system 660 may include one or more servers 662. Each server 662 may be a unitary server or a distributed server spanning multiple computers or multiple datacenters. Servers 662 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 662 may include hardware, software, or embedded logic components or a combination of two or more such components for carrying out the appropriate functionalities implemented or supported by server 662. In particular embodiments, social-networking system 660 may include one or more data stores 664. Data stores 664 may be used to store various types of information. In particular embodiments, the information stored in data stores 664 may be organized according to specific data structures. In particular embodiments, each data store 664 may be a relational, columnar, correlation, or other suitable database. Although this disclosure describes or illustrates particular types of databases, this disclosure contemplates any suitable types of databases. Particular embodiments may provide interfaces that enable a client system 630, a social-networking system 660, or a third-party system 670 to manage, retrieve, modify, add, or delete, the information stored in data store 664.

In particular embodiments, social-networking system 660 may store one or more social graphs in one or more data stores 664. In particular embodiments, a social graph may include multiple nodes—which may include multiple user nodes (each corresponding to a particular user) or multiple concept nodes (each corresponding to a particular concept)—and multiple edges connecting the nodes. Social-networking system 660 may provide users of the online social network the ability to communicate and interact with other users. In particular embodiments, users may join the online social network via social-networking system 660 and then add connections (e.g., relationships) to a number of other users of social-networking system 660 to whom they want to be connected. Herein, the term “friend” may refer to any other user of social-networking system 660 with whom a user has formed a connection, association, or relationship via social-networking system 660.

In particular embodiments, social-networking system 660 may provide users with the ability to take actions on various types of items or objects, supported by social-networking system 660. As an example and not by way of limitation, the items and objects may include groups or social networks to which users of social-networking system 660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 660 or by an external system of third-party system 670, which is separate from social-networking system 660 and coupled to social-networking system 660 via a network 610.

In particular embodiments, social-networking system 660 may be capable of linking a variety of entities. As an example and not by way of limitation, social-networking system 660 may enable users to interact with each other as well as receive content from third-party systems 670 or other entities, or to allow users to interact with these entities through an application programming interfaces (API) or other communication channels.

In particular embodiments, a third-party system 670 may include one or more types of servers, one or more data stores, one or more interfaces, including but not limited to APIs, one or more web services, one or more content sources, one or more networks, or any other suitable components, e.g., that servers may communicate with. A third-party system 670 may be operated by a different entity from an entity operating social-networking system 660. In particular embodiments, however, social-networking system 660 and third-party systems 670 may operate in conjunction with each other to provide social-networking services to users of social-networking system 660 or third-party systems 670. In this sense, social-networking system 660 may provide a platform, or backbone, which other systems, such as third-party systems 670, may use to provide social-networking services and functionality to users across the Internet.

In particular embodiments, a third-party system 670 may include a third-party content object provider. A third-party content object provider may include one or more sources of content objects, which may be communicated to a client system 630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 660 also includes user-generated content objects, which may enhance a user's interactions with social-networking system 660. User-generated content may include anything a user can add, upload, send, or “post” to social-networking system 660. As an example and not by way of limitation, a user communicates posts to social-networking system 660 from a client system 630. Posts may include data such as status updates or other textual data, location information, photos, videos, links, music or other similar data or media. Content may also be added to social-networking system 660 by a third-party through a “communication channel,” such as a newsfeed or stream.

In particular embodiments, social-networking system 660 may include a variety of servers, sub-systems, programs, modules, logs, and data stores. In particular embodiments, social-networking system 660 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 660 may also include suitable components such as network interfaces, security mechanisms, load balancers, failover servers, management-and-network-operations consoles, other suitable components, or any suitable combination thereof. In particular embodiments, social-networking system 660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 660 to one or more client systems 630 or one or more third-party system 670 via network 610. The web server may include a mail server or other messaging functionality for receiving and routing messages between social-networking system 660 and one or more client systems 630. An API-request server may allow a third-party system 670 to access information from social-networking system 660 by calling one or more APIs. An action logger may be used to receive communications from a web server about a user's actions on or off social-networking system 660. In conjunction with the action log, a third-party-content-object log may be maintained of user exposures to third-party-content objects. A notification controller may provide information regarding content objects to a client system 630. Information may be pushed to a client system 630 as notifications, or information may be pulled from client system 630 responsive to a request received from client system 630. Authorization servers may be used to enforce one or more privacy settings of the users of social-networking system 660. A privacy setting of a user determines how particular information associated with a user can be shared. The authorization server may allow users to opt in to or opt out of having their actions logged by social-networking system 660 or shared with other systems (e.g., third-party system 670), such as, for example, by setting appropriate privacy settings. Third-party-content-object stores may be used to store content objects received from third parties, such as a third-party system 670. Location stores may be used for storing location information received from client systems 630 associated with users. Advertisement-pricing modules may combine social information, the current time, location information, or other suitable information to provide relevant advertisements, in the form of notifications, to a user.

Social Graphs

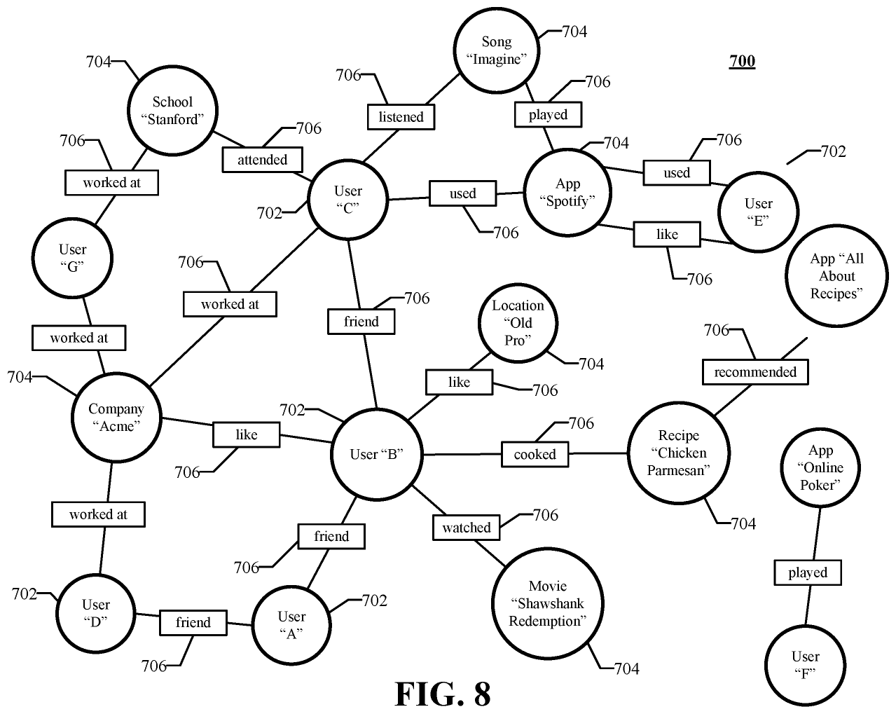

FIG. 8 illustrates example social graph 700. In some embodiments, the corruption detection system 100 (FIG. 1), corruption detection system 400 (FIG. 2), an error detection architecture 150 (FIGS. 3A-3B) and/or method 300 (FIG. 4), and/or method 370 (FIG. 5) already discussed may access social graph 700 to implement one or more aspects.

In particular embodiments, social-networking system 660 may store one or more social graphs 700 in one or more data stores. In particular embodiments, social graph 700 may include multiple nodes—which may include multiple user nodes 702 or multiple concept nodes 704—and multiple edges 706 connecting the nodes. Each node may be associated with a unique entity (i.e., user or concept), each of which may have a unique identifier (ID), such as a unique number or username. Example social graph 700 illustrated in FIG. 7 is shown, for didactic purposes, in a two-dimensional visual map representation. In particular embodiments, a social-networking system 660, client system 630, or third-party system 670 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular embodiments, a user node 702 may correspond to a user of social-networking system 660. As an example and not by way of limitation, a user may be an individual (human user), an entity (e.g., an enterprise, business, or third-party application), or a group (e.g., of individuals or entities) that interacts or communicates with or over social-networking system 660. In particular embodiments, when a user registers for an account with social-networking system 660, social-networking system 660 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 660. In particular embodiments, a user node 702 may be associated with information provided by a user or information gathered by various systems, including social-networking system 660. As an example and not by way of limitation, a user may provide his or her name, profile picture, contact information, birth date, sex, marital status, family status, employment, education background, preferences, interests, or other demographic information. In particular embodiments, a user node 702 may be associated with one or more data objects corresponding to information associated with a user. In particular embodiments, a user node 702 may correspond to one or more webpages.

In particular embodiments, a concept node 704 may correspond to a concept. As an example and not by way of limitation, a concept may correspond to a place (such as, for example, a movie theater, restaurant, landmark, or city); a website (such as, for example, a website associated with social-network system 660 or a third-party website associated with a web-application server); an entity (such as, for example, a person, business, group, sports team, or celebrity); a resource (such as, for example, an audio file, video file, digital photo, text file, structured document, or application) which may be located within social-networking system 660 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 660. As an example and not by way of limitation, information of a concept may include a name or a title; one or more images (e.g., an image of the cover page of a book); a location (e.g., an address or a geographical location); a web site (which may be associated with a URL); contact information (e.g., a phone number or an email address); other suitable concept information; or any suitable combination of such information. In particular embodiments, a concept node 704 may be associated with one or more data objects corresponding to information associated with concept node 704. In particular embodiments, a concept node 704 may correspond to one or more webpages.

In particular embodiments, a node in social graph 700 may represent or be represented by a webpage (which may be referred to as a “profile page”). Profile pages may be hosted by or accessible to social-networking system 660. Profile pages may also be hosted on third-party websites associated with a third-party system 670. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular embodiments, a concept node 704 may represent a third-party webpage or resource hosted by a third-party system 670. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 630 to send to social-networking system 660 a message indicating the user's action. In response to the message, social-networking system 660 may create an edge (e.g., a check-in-type edge) between a user node 702 corresponding to the user and a concept node 704 corresponding to the third-party webpage or resource and store edge 706 in one or more data stores.

In particular embodiments, a pair of nodes in social graph 700 may be connected to each other by one or more edges 706. An edge 706 connecting a pair of nodes may represent a relationship between the pair of nodes. In particular embodiments, an edge 706 may include or represent one or more data objects or attributes corresponding to the relationship between a pair of nodes. As an example and not by way of limitation, a first user may indicate that a second user is a “friend” of the first user. In response to this indication, social-networking system 660 may send a “friend request” to the second user. If the second user confirms the “friend request,” social-networking system 660 may create an edge 706 connecting the first user's user node 702 to the second user's user node 702 in social graph 700 and store edge 706 as social-graph information in one or more of data stores 664. In the example of FIG. 7, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706. The degree of separation between two objects represented by two nodes, respectively, is a count of edges in a shortest path connecting the two nodes in the social graph 700. As an example and not by way of limitation, in the social graph 700, the user node 702 of user “C” is connected to the user node 702 of user “A” via multiple paths including, for example, a first path directly passing through the user node 702 of user “B,” a second path passing through the concept node 704 of company “Acme” and the user node 702 of user “D,” and a third path passing through the user nodes 702 and concept nodes 704 representing school “Stanford,” user “G,” company “Acme,” and user “D.” User “C” and user “A” have a degree of separation of two because the shortest path connecting their corresponding nodes (i.e., the first path) includes two edges 706.

In particular embodiments, an edge 706 between a user node 702 and a concept node 704 may represent a particular action or activity performed by a user associated with user node 702 toward a concept associated with a concept node 704. As an example and not by way of limitation, as illustrated in FIG. 7, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 660 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 660 may create a “listened” edge 706 and a “used” edge (as illustrated in FIG. 6) between user nodes 702 corresponding to the user and concept nodes 704 corresponding to the song and application to indicate that the user listened to the song and used the application. Moreover, social-networking system 660 may create a “played” edge 706 (as illustrated in FIG. 6) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 7 between user node 702 for user “E” and concept node 704 for “SPOTIFY”).

In particular embodiments, social-networking system 660 may create an edge 706 between a user node 702 and a concept node 704 in social graph 700. As an example and not by way of limitation, a user viewing a concept-profile page (such as, for example, by using a web browser or a special-purpose application hosted by the user's client system 630) may indicate that he or she likes the concept represented by the concept node 704 by clicking or selecting a “Like” icon, which may cause the user's client system 630 to send to social-networking system 660 a message indicating the user's liking of the concept associated with the concept-profile page. In response to the message, social-networking system 660 may create an edge 706 between user node 702 associated with the user and concept node 704, as illustrated by “like” edge 706 between the user and concept node 704. In particular embodiments, social-networking system 660 may store an edge 706 in one or more data stores. In particular embodiments, an edge 706 may be automatically formed by social-networking system 660 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

Social Graph Affinity and Coefficient

In particular embodiments, social-networking system 660 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 670 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 660 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 660 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 660 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 660 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 660 may calculate a coefficient based on a user's actions. Social-networking system 660 may monitor such actions on the online social network, on a third-party system 670, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 660 may calculate a coefficient based on the user's actions with particular types of content. The content may be associated with the online social network, a third-party system 670, or another suitable system. The content may include users, profile pages, posts, news stories, headlines, instant messages, chat room conversations, emails, advertisements, pictures, video, music, other suitable objects, or any combination thereof. Social-networking system 660 may analyze a user's actions to determine whether one or more of the actions indicate an affinity for subject matter, content, other users, and so forth. As an example and not by way of limitation, if a user frequently posts content related to “coffee” or variants thereof, social-networking system 660 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 660 may calculate a coefficient based on the type of relationship between particular objects. Referencing the social graph 700, social-networking system 660 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than user nodes 702 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 660 may determine that the user has a higher coefficient with respect to the first photo than the second photo because having a tagged-in-type relationship with content may be assigned a higher weight and/or rating than having a like-type relationship with content. In particular embodiments, social-networking system 660 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 660 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular embodiments, social-networking system 660 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 630 of the user). A first user may be more interested in other users or concepts that are closer to the first user. As an example and not by way of limitation, if a user is one mile from an airport and two miles from a gas station, social-networking system 660 may determine that the user has a higher coefficient for the airport than the gas station based on the proximity of the airport to the user.

In particular embodiments, social-networking system 660 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 660 may provide information that is relevant to user's interests and current circumstances, increasing the likelihood that they will find such information of interest. In particular embodiments, social-networking system 660 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 660 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 660 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 670 (e.g., via an API or other communication channel), or from another suitable system. In response to the request, social-networking system 660 may calculate the coefficient (or access the coefficient information if it has previously been calculated and stored). In particular embodiments, social-networking system 660 may measure an affinity with respect to a particular process. Different processes (both internal and external to the online social network) may request a coefficient for a particular object or set of objects. Social-networking system 660 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

Privacy

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 704 corresponding to a particular photo may have a privacy setting specifying that the photo may only be accessed by users tagged in the photo and their friends. In particular embodiments, privacy settings may allow users to opt in or opt out of having their actions logged by social-networking system 660 or shared with other systems (e.g., third-party system 670). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 670, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 662 may be authorization/privacy servers for enforcing privacy settings. In response to a request from a user (or other entity) for a particular object stored in a data store 664, social-networking system 660 may send a request to the data store 664 for the object. The request may identify the user associated with the request and may only be sent to the user (or a client system 630 of the user) if the authorization server determines that the user is authorized to access the object based on the privacy settings associated with the object. If the requesting user is not authorized to access the object, the authorization server may prevent the requested object from being retrieved from the data store 664, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

Systems and Methods

FIG. 8 illustrates an example computer system 800. The system 800 may implement one or more aspects of corruption detection system 100 (FIG. 1), corruption detection system 400 (FIG. 2), an error detection architecture 150 (FIGS. 3A-3B) and/or method 300 (FIG. 4), and/or method 370 (FIG. 5) already discussed. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINTBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Thus, technology described herein may support a granular image enhancement selection process. The technology may substantially reduce the memory needed to store listings, the time needed to consummate a transaction and preserve valuable compute resources as well as bandwidth.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SOCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. At least one computer readable/writable storage medium comprising a set of instructions, which when executed by a computing system, cause the computing system to:
generate first data;
store the first data in a data storage of a first computing device to generate first stored data;
transmit the first data as first test data along a first integrity path comprising at least one first hardware device;
identify, with the first computing device, the first test data received from the first integrity path; and
compare the first stored data to the received first test data to determine if a first data path error exists in the first integrity path.

2. The at least one computer readable/writable storage medium of claim 1, wherein to compare the first stored data to the received first test data to determine if the first data path error exists, the instructions, when executed, cause the computing system to:
determine if the first stored data matches the received first test data;
determine that the first data path error does exist if the first stored data does not match the received first test data; and
determine that the first data path error does not exist if the first stored data does not match the received first test data.

3. The at least one computer readable/writable storage medium of claim 1, wherein, the instructions, when executed, cause the computing system to determine that the first data path error exists based on the first stored data not matching the received first test data;
wherein the set of instructions, which when executed by the computing system, cause the computing system to:
determine whether a second data path error exist along a second integrity path that at least partially overlaps with the first integrity path, wherein the second integrity path includes at least one second hardware device; and
identify a failing device based on whether the second data path error exists in the second integrity path.

4. The at least one computer readable/writable storage medium of claim 3, wherein to identify the failing device, the set of instructions, which when executed by the computing system, cause the computing system to:
when the second data path error exists in the second integrity path, identify that the failing device is a common device to both the first integrity path and the second integrity path; and
when the second data path error does not exist in the second integrity path, determine that the failing device is a device that is only in the first integrity path but not the second integrity path.

5. The at least one computer readable/writable storage medium of claim 3, wherein the set of instructions, which when executed by the computing system, cause the computing system to:
bypass the failing device for operations.

6. The at least one computer readable/writable storage medium of claim 1, wherein the set of instructions, which when executed by the computing system, cause the computing system to:
determine that the first data path error does not exist in the first integrity path;
expand the first integrity path to generate an expanded first integrity path;
store second data in the data storage of the first computing device to generate second stored data;
transmit the second data as second test data along the expanded first integrity path;
receive the second test data from the expanded first integrity path; and
compare the second stored data to the received second test data to determine if a second data path error exists in the expanded first integrity path.

7. The at least one computer readable/writable storage medium of claim 1, wherein the first hardware device includes the first computing device and one or more a network switch or network interface card.

8. A system comprising:
one or more processors; and
a memory coupled to the one or more processors, the memory comprising instructions executable by the one or more processors, the one or more processors being operable when executing the instructions to:
generate first data;
store the first data in a data storage of a first computing device to generate first stored data;
transmit the first data as first test data along a first integrity path comprising at least one first hardware device;
identify, with the first computing device, the first test data received from the first integrity path; and
compare the first stored data to the received first test data to determine if a first data path error exists in the first integrity path.

9. The system of claim 8, wherein to compare the first stored data to the received first test data to determine if the first data path error exists, the one or more processors are further operable when executing the instructions to:
determine if the first stored data matches the received first test data;
determine that the first data path error does exist if the first stored data does not match the received first test data; and
determine that the first data path error does not exist if the first stored data does not match the received first test data.

10. The system of claim 8, wherein the one or more processors are further operable when executing the instructions to determine that the first data path error exists based on the first stored data not matching the received first test data;
wherein the one or more processors are further operable when executing the instructions to:
determine whether a second data path error exist along a second integrity path that at least partially overlaps with the first integrity path, wherein the second integrity path includes at least one second hardware device; and
identify a failing device based on whether the second data path error exists in the second integrity path.

11. The system of claim 10, wherein to identify the failing device, the one or more processors are further operable when executing the instructions to:
when the second data path error exists in the second integrity path, identify that the failing device is a common device to both the first integrity path and the second integrity path; and
when the second data path error does not exist in the second integrity path, determine that the failing device is a device that is only in the first integrity path but not the second integrity path.

12. The system of claim 10, further wherein the one or more processors are further operable when executing the instructions to:
bypass the failing device for operations.

13. The system of claim 8, wherein the one or more processors are further operable when executing the instructions to:
determine that the first data path error does not exist in the first integrity path;
expand the first integrity path to generate an expanded first integrity path;
store second data in the data storage of the first computing device to generate second stored data;
transmit the second data as second test data along the expanded first integrity path;
receive the second test data from the expanded first integrity path; and
compare the second stored data to the received second test data to determine if a second data path error exists in the expanded first integrity path.

14. The system of claim 8, wherein the first hardware device includes the first computing device and one or more a network switch or network interface card.

15. A method comprising:
generating first data;
storing the first data in a data storage of a first computing device to generate first stored data;
transmitting the first data as first test data along a first integrity path comprising at least one first hardware device;
identifying, with the first computing device, the first test data received from the first integrity path; and
comparing the first stored data to the received first test data to determine if a first data path error exists in the first integrity path.

16. The method of claim 15, wherein the comparing comprises:
determining if the first stored data matches the received first test data;
determining that the first data path error does exist if the first stored data does not match the received first test data; and
determining that the first data path error does not exist if the first stored data does not match the received first test data.

17. The method of claim 15, wherein the comparing includes determining that the first data path error exists in the first integrity path, the method further comprising:
determining whether a second data path error exist along a second integrity path that at least partially overlaps with the first integrity path, wherein the second integrity path includes at least one second hardware device; and
identifying a failing device based on whether the second data path error exists in the second integrity path.

18. The method of claim 17, wherein the identifying comprises:
when the second data path error exists in the second integrity path, identify that the failing device is a common device to both the first integrity path and the second integrity path; and
when the second data path error does not exist in the second integrity path, determine that the failing device is a device that is only in the first integrity path but not the second integrity path.

19. The method of claim 17, further comprising:
bypassing the failing device for operations.

20. The method of claim 15, further comprising:
determining that the first data path error does not exist in the first integrity path;
expanding the first integrity path to generate an expanded first integrity path;
storing second data in the data storage of the first computing device to generate second stored data;
transmitting the second data as second test data along the expanded first integrity path;
receiving the second test data from the expanded first integrity path; and
comparing the second stored data to the received second test data to determine if a second data path error exists in the expanded first integrity path, wherein the first hardware device includes the first computing device and one or more a network switch or network interface card.
